(19) United States
(12) Patent Application Publication
(10) Pub. No.: US 2021/0058682 A1
(43) Pub. Date: Feb. 25, 2021

(54) SYSTEM AND METHOD FOR STORING MULTIMEDIA RESOURCES

(71) Applicant: BEIJING DIDI INFINITY TECHNOLOGY AND DEVELOPMENT CO., LTD., Beijing (CN)

(72) Inventor: Gengxin WU, Hangzhou (CN)

(73) Assignee: BEIJING DIDI INFINITY TECHNOLOGY AND DEVELOPMENT CO., LTD., Beijing (CN)

(21) Appl. No.: 17/067,747

(22) Filed: Oct. 11, 2020

Related U.S. Application Data
(63) Continuation of application No. PCT/CN2019/082193, filed on Apr. 11, 2019.

(30) Foreign Application Priority Data
Apr. 11, 2018 (CN) 201810322229.5

(51) Int. Cl. H04N 21/845; H04N 21/472; H04N 21/433; H04N 21/8547

(52) U.S. Cl. CPC H04N 21/8456; H04N 21/8547; H04N 21/4334; H04N 21/47202

(57) ABSTRACT

A system and a method for storing a multimedia resource are provided. The method may include determining a time slice of the multimedia resource having a specified format in real time. The method may further include storing the multimedia resource to a corresponding file based on a corresponding relation between the time slice and a preset time slice.

### CROSS-REFERENCE TO RELATED APPLICATIONS

This application is a continuation of International Patent Application No. PCT/CN2019/082193, filed on Apr. 11, 2019, which claims priority to Chinese Patent Applications No. 201810322229.5 filed on Apr. 11, 2018, the contents each of which are hereby incorporated by reference.

### TECHNICAL FIELD

The present disclosure generally relates to data storage technology, and in particular, relates to systems and methods for storing multimedia resources.

### BACKGROUND

In the digital age, various multimedia resources may be provided to people for meeting various needs, such as entertainment, work, etc. In some cases, the multimedia resources may be stored in a digital device. For example, videos and audios may be recorded by an automobile data recorder, videos, photos and audios may be recorded by a monitor, or by other home appliances via smart home application. During the data storage, a thread for storing the multimedia resource may be executed. Each thread may be independent. However, when multiple multimedia resources need to be stored at the same time, these multimedia resources may not have the same timestamp corresponding to the storage time, which may cause disorder when coming to synchronous synthesis of them. Therefore, it is desirable to develop systems and methods for storing the multiple multimedia resources so as to achieve the time synchronization of multimedia resource synthesis.

### SUMMARY

According to an aspect of the present disclosure, a method is provided. The method may include one or more of the following operations. At least one processor may determine a time slice of the multimedia resource having a specified format in real time. The at least one processor may store the multimedia resource to a corresponding file based on a corresponding relation between the time slice and a preset time slice.

In some embodiments, the at least one processor may determine a plurality of preset time slices based on a time sequence, and store the plurality of preset time slices. Each of the plurality of preset time slices and the corresponding file may be named after a start time of the preset time slice.

In some embodiments, the at least one processor may determine whether the time slice of the multimedia resource matches the preset time slice. In response to a determination that the time slice of the multimedia resource does not match the preset time slice, the at least one processor may designate a name of the file storing the multimedia resource based on the time slice of the multimedia resource.

In some embodiments, the at least one processor may determine whether the time slice of the multimedia resource matches the preset time slice. In response to a determination that the time slice of the multimedia resource matches the preset time slice, the at least one processor may determine a time length between a start time of the time slice of the multimedia resource and a storage time, and store the multimedia resource to the corresponding file based on the time length.

In some embodiments, the at least one processor may determine whether the time length is greater than or equal to a duration of the preset time slice. In response to a determination that the time length is greater than or equal to the duration of the preset time slice, the at least one processor may store the multimedia resource to a file corresponding to a second preset time slice. The second preset time slice may be a next time slice adjacent to the preset time slice. In response to a determination that the time length is less than the duration of the preset time slice, the at least one processor may store the multimedia resource to the corresponding file corresponding to the preset time slice.

In some embodiments, the at least one processor may start a thread synchronization lock. The at least one processor may subsequently designate the storage time of the multimedia resource as the name of the second preset time slice, and designate the name of the second preset time slice as the name of the file.

In some embodiments, the multimedia resource may include at least one of a digital image format, an audio format, or a video format.

According to another aspect of the present disclosure, a system is provided. The system may include at least one storage device, at least one processor in communication with the at least one storage device. The at least one storage device may include one or more sets of instructions. When executing the one or more sets of instructions, the at least one processor may determine a time slice of the multimedia resource having a specified format in real time, and store the multimedia resource to a corresponding file based on a corresponding relation between the time slice and a preset time slice.

According to another aspect of the present disclosure, a device is provided. The device may at least include a determination unit for determining a time slice of the multimedia resource having a specified format in real time, and a storing unit for storing the multimedia resource to a corresponding file based on a corresponding relation between the time slice and a preset time slice.

According to another aspect of the present disclosure, a non-transitory computer readable medium is provided. The non-transitory computer readable medium may comprise executable instructions that cause at least one processor to effectuate a method. The method may include one or more of the following operations. At least one processor may determine a time slice of the multimedia resource having a specified format in real time. The at least one processor may store the multimedia resource to a corresponding file based on a corresponding relation between the time slice and a preset time slice.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals present similar structures throughout the several views of the drawings, and wherein:

FIG. 1 is a flowchart illustrating an exemplary process for storing multimedia resources according to some embodiments of the present disclosure;

FIG. 2 is a block diagram illustrating an exemplary device for storing multimedia resources according to some embodiments of the present disclosure;

FIG. 3 is a block diagram illustrating an exemplary computer storage device according to some embodiments of the present disclosure; and

FIG. 4 is a schematic diagram illustrating an exemplary scheme for storing multimedia resources according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

It will be understood that the term “system,” “module,” and/or “block” used herein are one method to distinguish different components, elements, parts, section or assembly of different level in ascending order. However, the terms may be displaced by another expression if they achieve the same purpose.

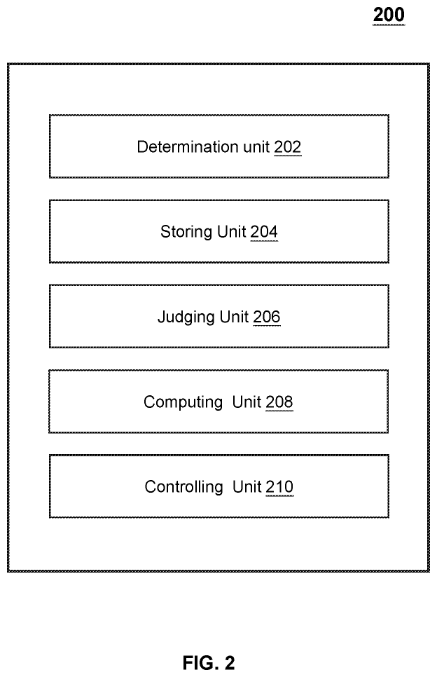

The term “module,” or “block,” as used herein, refers to logic embodied in hardware or firmware, or to a collection of software instructions. A module or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or themselves, and/or may be invoked in response to detected events or interrupts. Software modules/units/blocks configured for execution on computing devices (e.g., the multimedia resource storing device 200 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an Electrically Programmable Read-Only-Memory (EPROM). It will be further appreciated that hardware modules/units/blocks may be included in connected logic components, such as gates and flip-flops, and/or can be included in programmable units, such as programmable gate arrays or processors. The modules/units/blocks or computing device functionality described herein may be implemented as software modules/units/blocks but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It will be understood that when a module or block is referred to as being “connected to,” or “coupled to,” another module, or block, it may be directly connected or coupled to, or communicate with the other module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

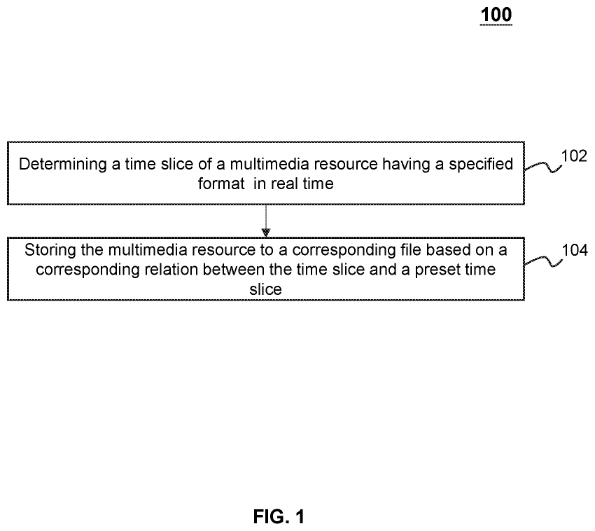

FIG. 1 is a flowchart illustrating an exemplary process for storing multimedia resources according to some embodiments of the present disclosure. In some embodiments, process 100 for storing the multimedia resources may be implemented by a multimedia resource storing device (e.g., a multimedia resource storing device 200 shown in FIG. 2). In some embodiments, the process 100 may also be implemented as one or more instructions stored in a storage medium and called and/or executed by a processor (e.g., a processor of the multimedia resource storing device 200). The operations of the illustrated process presented below are intended to be illustrative. In some embodiments, the process 100 may be accomplished with one or more additional operations not described, and/or without one or more of the operations discussed. Additionally, the order in which the operations of the process 100 as illustrated in FIG. 1 and described below is not intended to be limiting.

In 102, during storing the multimedia resource, the processor may determine a time slice of the multimedia resource having a specified format in real time.

In some embodiments, the specified format may include but not limited to a digital image format, an audio format, or a video format. Exemplary digital image format may include bmp, jpg, png, tiff, gif, pcx, tga, exif, fpx, fvg, ps, or the like, or any combination thereof. Exemplary audio file format may include CD, WAVE, AIFF, AU, MP3, MIDI, WAM, RealAudio, VQF, OggVorbits, AAC, AP, or the like, or any combination thereof. Exemplary video file format may include MPEG, MPG, DAT, MP4, or the like, or any combination thereof.

In 104, the processor may store the multimedia resource to a corresponding file based on a corresponding relation between the time slice and a preset time slice.

In some embodiments, during the storing the multimedia resource in real time, multiple multimedia resources need to be synchronized based on the time slice(s). The time slice may be designated as a timestamp associated with the multimedia resource to be stored. The processor may store the multimedia resource to a corresponding file associated with the time slice and/or the timestamp. Specifically, the processor may store the multimedia resource to the corresponding file based on a relation between the time slice and the preset time slice. Merely for illustration, assuming that a camera needs to record an audio resource A and a video resource B synchronously, the time slice of both audio resource A and video resource B are recorded as T1 which corresponds to the preset time slice T1. The processor may store the audio resource A and the video resource B to the file corresponding to the preset time slice T1, respectively. In some embodiments, the processor may further synthesize the audio resource A and the video resource B stored in the file corresponding to the preset time slice T1 so as to keep time synchronization of the audio resource A and the video resource B.

For example, let the start time of the N-th time slice be t_{N}, where N is a positive integer that is greater than or equal to 1. The time length of the time slice is d. The start time may be designated as the name of the N-th time slice, that is t_{N}. In some embodiments, because the multimedia resource may be stored in accordance with each time slice, the timestamp of the multimedia resource may also be determined as t_{N} if the current time slice of the multimedia resource corresponds to the time slice t_{N}.

It may be beneficial to improve synthetic accuracy of the multiple multimedia resources based on the determined time slice in real time which each of multiple multimedia resources belongs to. The multiple multimedia resources may include the audio resources, the video resources, the picture resources, or the like, or any combination thereof. In some embodiments, in the process of synthesizing the multiple multimedia resources, the processor may designate the time slice corresponding to each multimedia resource as the timestamp of the each resource. The processor may further synthesize the multiple multimedia resources that have the same timestamp so as to achieve the time synchronization of multimedia resource synthesis.

In some embodiments, prior to the storing the multimedia resource, the processor may determine a plurality of preset time slices based on a time sequence (e.g., the preset time slice 410 as shown in FIG. 4). For example, 10:00˜10:30 may be preset as a first preset time slice, 10:30˜11:00 may be preset as a second preset time slice. The processor may store the plurality of preset time slices to the storage medium (e.g., the computer storing device 300). In some embodiments, each of the plurality of preset time slices may be named after the start time of the preset time slice. In some embodiments, the corresponding file of each preset time slice may also be named after the start time of the preset time slice.

In some embodiments, the plurality of preset time slices may correspond to the time slices associated with the files that are used to store the multimedia resources. Each of the plurality of preset time slices may be named after the start time of the preset time slices, and arranged in the time sequence. In some embodiments, the preset time slice may include a preset time duration of the preset time slice (e.g., the time duration L illustrated in FIG. 4). In some embodiments, the processor may generate a plurality of files for storing the multimedia resource that satisfies the preset time slice. The corresponding file may be named after the start time of the preset time slice.

For example, let the start time of the N-th preset time slice be T_{N}, where N is a positive integer that is greater than or equal to 1. The time duration of the preset time slice T_{N} is L. The name of the preset time slice may be denoted as T_{N}. If a time slice of the multimedia resource to be stored satisfies the preset time slice T_{N}, that is, the start time of the time slice of the multimedia resource is T_{N}, the processor may store the multimedia resource to the corresponding file that is named after the start time of the preset time slice. In other words, the name of the corresponding file for storing the multimedia resource is also designated as T_{N}.

In some embodiments, the processor may determine whether the time slice of the multimedia resource matches the preset time slice. In response to a determination that the time slice of the multimedia resource does not match the preset time slice, the processor may designate the name of the file storing the multimedia resource based on the time slice of the multimedia resource. Merely for illustration, when the start time of the time slice of the multimedia resource is not the same as the start time of the preset time slice, the processor determines that the time slice of the multimedia resource does not match the preset time slice. In the case, the processor may designate the start time of the time slice of the multimedia resource, i.e., the start time of the time slice of to which the multimedia resource belonging, as the name of the file storing the multimedia resource. Thus, the name of the corresponding storage file may correspond to the time slice of the multimedia resource, and be a timestamp for storing the multimedia resource. To guarantee the time synchronization of the multimedia resources when the processor synthesizes multiple multimedia resources, the processor may synthesize the multimedia resources that are stored in the files having the same name. It should be understood that the same file name may indicate the multimedia resources having the same time slice and/or timestamp.

In some embodiments, when the start time of the time slice of the multimedia resource is the same as the start time of the preset time slice, the processor determines that the time slice of the multimedia resource matches the preset time slice. In response to the determination that the time slice of the multimedia resource matches the preset time slice, the processor may determine a time length between the start time of the time slice of the multimedia resource and a storage time. The storage time may refer to the time when the processor decides to store the multimedia resource. The processor may further store the multimedia resource to the corresponding file based on the time length to improve the synchronization of multimedia resource synthesis.

Specifically, the processor may determine whether the time length is greater than or equal to a duration of the preset time slice. In response to the determination that the time length is greater than or equal to the duration of the preset time slice, the processor may store the multimedia resource to a file corresponding to a second preset time slice. The second preset time slice may be a next time slice adjacent to the preset time slice. In response to a determination that the time length is less than the duration of the preset time slice, the processor may store the multimedia resource to the corresponding file corresponding to the preset time slice.

For example, assuming that the time length of the time slice of the current multimedia resource is d1, and the time length of a first preset time slice is L1. The start time of both the time slice of the current multimedia resource and the first preset time slice are the same. In other words, the processor may determine that the time slice of the multimedia resource matches the first preset time slice. If d1 is less than L1, in this case, the storage space of the first file corresponding to the first preset time slice may be enough to store the current multimedia resource. The processor may store the current multimedia resource to the first file corresponding to the first preset time slice. The name of the first preset time slice, that is, the start time of the first preset time slice, may be designated as the name of the first file. If d1 is greater than or equal to L1, in this case, the storage space of the first file corresponding to the first preset time slice may be not enough to store the current multimedia resource. The processor may need the second file to store the multimedia resource. The second file may refer to a file corresponding to the second preset time slice, and the second preset time slice may be the next time slice adjacent to the first preset time slice.

In some embodiments, in the process of storing the multimedia resource to the second file corresponding to the second preset time slice, the processor may start a thread synchronization lock. The processor may subsequently designate the storage time of the multimedia resource as the name of the second preset time slice. In some embodiments, the storage time may be different from the start time of the second preset time slice. The processor may modify the name of second preset time slice from the original start time to the current storage time. In some embodiments, the processor may further designate the name of the second preset time slice as the name of the second file, that is, the storage time. The multimedia resource may be stored to the second file. It should be understood that the thread synchronization lock may reduce a conflict of the data storage thread.

In some embodiments, the processor may further synthesize the multiple multimedia resources having the same timestamp, which may achieve the time synchronization of multimedia resource synthesis. For example, the processor may obtain the multiple multimedia resources from one or more files having the same name, and synthesize the one or more multimedia resources.

FIG. 2 is a block diagram illustrating an exemplary device for storing multimedia resources according to some embodiments of the present disclosure. As shown in FIG. 2, multimedia resource storing device 200 may include at least one processing device to perform exemplary processes or methods described in the present disclosure (e.g., the process 100 illustrated in FIG. 1). In some embodiments, the at least one processing device may be in communication with a computer-readable storage medium and may execute instructions stored in the computer-readable storage medium to perform the exemplary processes or methods described in the present disclosure (e.g., the process 100 illustrated in FIG. 1). In some embodiments, the computer-readable storage medium may be integrated to the multimedia resource storing device 200. In some embodiments, the computer-readable storage medium may separate from the multimedia resource storing device 200. As shown in FIG. 2, the multimedia resource storing device 200 may include the at least one processing device including a determination unit 202, a storing unit 204, a judging unit 206, a computing unit 208, and a controlling unit 210.

In some embodiments, the determination unit 202 may be configured to determine a time slice of the multimedia resource having a specified format in real time during the storing of the multimedia resource.

In some embodiments, the specified format may include but not limited to a digital image format, an audio format, or a video format. Exemplary digital image format may include bmp, jpg, png, tiff, gif, pcx, tga, exif, fpx, fvg, ps, or the like, or any combination thereof. Exemplary audio file format may include CD, WAVE, AIFF, AU, MP3, MIDI, WAM, RealAudio, VQF, OggVorbits, AAC, AP, or the like, or any combination thereof. Exemplary video file format may include MPEG, MPG, DAT, MP4, or the like, or any combination thereof.

In some embodiments, the storing unit 204 may be configured to store the multimedia resource to a corresponding file based on a corresponding relation between the time slice and a preset time slice.

In some embodiments, during the storing the multimedia resource in real time, multiple multimedia resources need to be synchronized based on the time slice(s). The time slice may be designated as a timestamp associated with the multimedia resource to be stored. The processor may store the multimedia resource to a corresponding file associated with the time slice. Specifically, the processor may store the multimedia resource to the corresponding file based on a relation between the time slice and a preset time slice.

For example, let the start time of the N-th time slice be t_{N}, where N is a positive integer that is greater than or equal to 1. The time length of the time slice is d. The start time may be designated as the name of the N-th time slice, that is t_{N}. In some embodiments, because the multimedia resource may be stored in accordance with each time slice, a timestamp of the multimedia resource may be determined as t_{N} if current time slice of the multimedia resource corresponds to the time slice t_{N}.

It may be beneficial to improve synthetic accuracy of the multiple multimedia resources based on the determined time slice to which each of the multiple multimedia resources belongs. The multiple multimedia resources may include the audio resources, the video resources, the picture resources, or the like, or any combination thereof. For example, in the process of synthesizing the multiple multimedia resources, the processor may designate the time slice corresponding to each multimedia resource as the timestamp of the each resource. The processor may further synthesize the multiple multimedia resources that have the same timestamp so as to achieve the time synchronization of multimedia resource synthesis.

In some embodiments, the storing unit 204 may be further configured to determine a plurality of preset time slices based on a time sequence (e.g., the preset time slice 410 as shown in FIG. 4). For example, 10:00˜10:30 may be preset as a first preset time slice, 10:30˜11:00 may be preset as a second preset time slice. The storing unit 204 may store the plurality of preset time slices to a storage medium (e.g., the computer storing device 300). In some embodiments, each of the plurality of preset time slices may be named after the start time of the preset time slice. In some embodiments, the corresponding file of each preset time slices may also be named after the start time of the preset time slice.

For example, assuming that the start time of the N-th preset time slice is T_{N}, where N is a positive integer that is greater than or equal to 1. The time duration of the preset time slice T_{N} is L. The name of the preset time slice may be denoted as T_{N}. If a time slice of the multimedia resource to be stored satisfies the preset time slice T_{N}, that is, the start time of the time slice of the multimedia resource is T_{N}, the processor may store the multimedia resource to the corresponding file that is named after the start time of the preset time slice. In other words, the name of the corresponding file for storing the multimedia resource is also designated as T_{N}.

In some embodiments, the judging unit 206 may be configured to determine whether the time slice of the multimedia resource matches the preset time slice. In response to a determination that the time slice of the multimedia resource does not match the preset time slice, the determination unit 202 may designate the name of the file storing the multimedia resource based on the time slice of the multimedia resource. Merely for illustration, when the start time of the time slice of the multimedia resource is not the same as the start time of the preset time slice, the judging unit 206 determines that the time slice of the multimedia resource does not match the preset time slice. In the case, the determination unit 202 may designate the start time of the time slice of the multimedia resource, i.e., the start time of the time slice of to which the multimedia resource belonging, as the name of the file storing the multimedia resource. Thus, the name of the corresponding storage file may correspond to the time slice of the multimedia resource, and be a timestamp for storing the multimedia resource. To guarantee the time synchronization of multimedia resources when the processor synthesizes multiple multimedia resources, a processor may synthesize the multimedia resources that are stored in the files having the same name. It should be understood that the same file name may indicate the multimedia resources having the same time slice and/or timestamp.

In some embodiments, when the start time of the time slice of the multimedia resource is the same as the start time of the preset time slice, the judging unit 206 determines that the time slice of the multimedia resource matches the preset time slice. In response to the determination that the time slice of the multimedia resource matches the preset time slice, the computing unit 208 may be further configured to determine a time length between the start time of the time slice of the multimedia resource and a storage time. The storage time may refer to the time when the processor decides to store the multimedia resource. The storing unit 204 may further store the multimedia resource to the corresponding file based on the time length to improve the synchronization of multimedia resource synthesis.

Specifically, the judging unit 206 may determine whether the time length is greater than or equal to a duration of the preset time slice. In response to the determination that the time length is greater than or equal to the duration of the preset time slice, the storing unit 204 may store the multimedia resource to a file corresponding to a second preset time slice. The second preset time slice may be a next time slice adjacent to the preset time slice. In response to a determination that the time length is less than the duration of the preset time slice, the storing unit 204 may store the multimedia resource to the corresponding file corresponding to the preset time slice.

For example, assuming that the time length of the time slice of the current multimedia resource is d1, and the time length of a first preset time slice is L1. The start time of both the time slice of the current multimedia resource and the first preset time slice are the same. In other words, the judging unit 206 may determine that the time slice of the multimedia resource matches the first preset time slice. If d1 is less than L1, in this case, the storage space of the first file corresponding to the first preset time slice may be enough to store the current multimedia resource. The storing unit 204 may store the current multimedia resource to the first file corresponding to the first preset time slice. The name of the first preset time slice, that is, the start time of the first preset time slice, may be designated as the name of the first file. If d1 is greater than or equal to L1, in this case, the storage space of the first file corresponding to the first preset time slice may be not enough to store the current multimedia resource. The storing unit 204 may need the second file to store the multimedia resource. The second file may refer to a file corresponding to the second preset time slice, and the second preset time slice may be the next time slice adjacent to the first preset time slice.

In some embodiments, in the process of storing the multimedia resource to the second file corresponding to the second preset time slice, the controlling unit 210 may start a thread synchronization lock. The determination unit 202 may subsequently designate the storage time of the multimedia resource as the name of the second preset time slice. In some embodiments, the storage time may be different from the start time of the second preset time slice. The determination unit 202 may modify the name of second preset time slice from the original start time to the current storage time. In some embodiments, the determination unit 202 may further designate the name of the second preset time slice as the name of the second file, that is, the storage time. The multimedia resource may be stored to the second file. It should be understood that the thread synchronization lock may reduce a conflict of the data storage thread.

It should be noted that the descriptions above in relation to the at least one processing device is provided for the purposes of illustration, and not intended to limit the scope of the present disclosure. For persons having ordinary skills in the art, various variations and modifications may be conducted under the guidance of the present disclosure. For example, the judging unit 206 and the computing unit 208 may be integrated to a single unit. However, those variations and modifications do not depart the scope of the present disclosure.

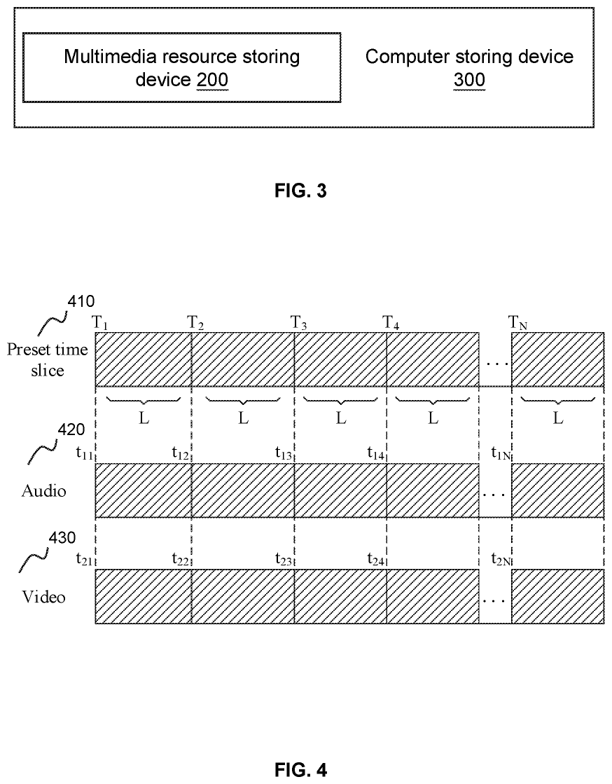

FIG. 3 is a block diagram illustrating an exemplary storage device according to some embodiments of the present disclosure. As shown in FIG. 3, a computer storing device 300 may at least include the multimedia resource storing device 200 illustrated in FIG. 2. In some embodiments, the determination unit 202, the storing unit 204, the judging unit 206, the computing unit 208, and the controlling unit 210 in the multimedia resource storing device 200 may include at least one of a central processor unit (CPU), a digital signal processor (DSP), a programmable logic controller (PLC), or the like, or any combination thereof. The computer storage device 300 may be configured to process the multimedia resources, such as, recording, synthesizing, or playing the multimedia resources.

FIG. 4 is a schematic diagram illustrating an exemplary scheme for storing multimedia resources according to some embodiments of the present disclosure. As shown in FIG. 4, reference numeral 410 denotes a plurality of preset time slices. As described in connection with FIG. 2, the storing unit 204 generates and stores the plurality of preset time slices based on a time sequence. For example, the start time of the N-th preset time slice may be T_{N}, where N is a positive integer that is greater than or equal to 1. The time duration of the preset time slice may be equal to L. The preset time slice may be named after the start time of the preset time slice itself, such as, T₁, T₂, . . . , T_{N}. In some embodiments, the time duration of each of the plurality of the preset time slices 410 may be equal, or the time duration of a portion of the plurality of the preset time slices 410 may be equal.

In some embodiments, during storing the multimedia resources, each multimedia resource may be loaded to a single thread operation. For example, as shown in FIG. 4, reference numeral 420 denotes an audio resource, reference numeral 430 denotes a video resource. The audio resource 420 may be load to a first thread for storing the audio resource, and the video resource 430 may be load to a second thread for storing the video resource. In some embodiments, the first thread may be independent from the second thread.

Merely for illustration, during storing audio resource, the audio resource 420 may be divided to a plurality of time slices, such as, t₁₁, t₁₂, . . . , t_{1N}. In some embodiments, each time slice may be named after its own start time. The time length of the time slice regarding the audio resource 420 may be equal to d. The processor may determine whether the time slice of the audio resource 420 matches a preset time slice. In some embodiments, if the time slice of the audio resource does not match the preset time slice, for example, t₁₁ is not the same as T₁, the processor may store the audio resource corresponding to the time slice t₁₁ to a first file. The first file may be named after the start time of the time slice t₁₁, that is, t₁₁. Similarly, the processor may store the audio resources associated with other time slices to corresponding files. In some embodiments, if the time slice of the audio resource 420 matches the preset time slice, for example, t₁₁ is the same as T₁, the processor may further determine whether the time length of the time slice (i.e., d) is greater than or equal to the duration of the preset time slice (i.e., L). If d is less than L, the processor may store the audio resource corresponding to the time slice t₁₁ to a file corresponding to the preset time slice T₁. If d is equal to or less than L, the processor may store the audio resource corresponding to the time slice t₁₁ to a file associated with the next time slice adjacent to the first preset time slice (e.g., the file corresponding to the preset time slice T₂).

Similarly, during storing the video resource 430, the video resource 430 may be divided to a plurality of time slices, such as, t₂₁, t₂₂, . . . , t_{2N}. The processor may store the video resource 430 corresponding to each of the plurality of time slices to the corresponding file based on the relation of the time slice and the preset time slice.

In some embodiments, the plurality of preset time slices 410 may be preset. The duration of each preset time slice may be preset as an equal time length, L. During storing the audio resource 420 and the video resource 430 at the same time, the audio resource 420 and the video resource 430 may be divided to the plurality of time slices respectively based on the plurality of preset time slices. Merely for illustration, the audio resource 420 may be divided to the first plurality of time slices that are the same as the plurality of preset time slices. For instance, the start time of the time slice t₁₁ is the same as the start time of the preset time slice T₁, and the time length of the time slice t₁₁ is equal to the duration of the preset time slice T₁, that is, d=L. Each of the first plurality of time slices of the audio resource 420 corresponds to the preset time slice 410. Similarly, the video resource 430 may be divided to the second plurality of time slices that correspond to the plurality of preset time slices 410. Each of the second plurality of time slices of the video resource 430 corresponds to the preset time slice 410. The audio resource 420 and the video resource 430 may be stored to the file corresponding to the preset time slice respectively. In some embodiments, the audio resource 420 and the video resource 430 may be synthesized based on the time slice which the audio resource and the video resource belongs to. For example, the processor may synthesize the audio resource 420 and the video resource 430 that belong to the same time slice so as to achieve the time synchronization of multimedia resource synthesis.

A non-transitory computer readable medium may be provided for storing one or more multimedia resources. The non-transitory computer readable medium may include at least one set of instructions for storing the one or more multimedia resources. When at least one processor invokes the at least one set of instructions, the at least one processor may determine a time slice of the multimedia resource having a specified format in real time during storing the multimedia resource. The at least one processor may store the multimedia resource to a corresponding file based on a corresponding relation between the time slice and a preset time slice. More descriptions about the storing the one or more multimedia resources may be found elsewhere in the present disclosure (e.g., FIGS. 1-2, and the descriptions thereof), and not described repeatedly.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A method for storing a multimedia resource, the method comprising:
determining a time slice of the multimedia resource having a specified format in real time; and
storing the multimedia resource to a corresponding file based on a corresponding relation between the time slice and a preset time slice.

2. The method of claim 1, wherein the method further comprising: prior to the storing the multimedia resource,
determining a plurality of preset time slices based on a time sequence; and
storing the plurality of preset time slices, wherein each of the plurality of preset time slices and the corresponding file are named after a start time of the preset time slice.

3. The method of claim 2, wherein the storing the multimedia resource to a corresponding file based on the corresponding relation between the time slice and the preset time slice further includes:
determining whether the time slice of the multimedia resource matches the preset time slice; and
in response to a determination that the time slice of the multimedia resource does not match the preset time slice, designating a name of the file storing the multimedia resource based on the time slice of the multimedia resource.

4. The method of claim 2, wherein the storing the multimedia resource to a corresponding file based on the corresponding relation between the time slice and the preset time slice further includes:
determining whether the time slice of the multimedia resource matches the preset time slice;
in response to a determination that the time slice of the multimedia resource matches the preset time slice, determining a time length between a start time of the time slice of the multimedia resource and a storage time; and
storing the multimedia resource to the corresponding file based on the time length.

5. The method of claim 4, wherein the storing the multimedia resource to the corresponding file based on the time length further includes:
determining whether the time length is greater than or equal to a duration of the preset time slice;
in response to a determination that the time length is greater than or equal to the duration of the preset time slice, storing the multimedia resource to a file corresponding to a second preset time slice, the second preset time slice being a next time slice adjacent to the preset time slice; and
in response to a determination that the time length is less than the duration of the preset time slice, storing the multimedia resource to the corresponding file corresponding to the preset time slice.

6. The method of claim 5, wherein in response to the determination that the time length is greater than or equal to the duration of the preset time slice, the storing the multimedia resource to the file corresponding to the second preset time slice further includes:
starting a thread synchronization lock;
subsequently designating the storage time of the multimedia resource as the name of the second preset time slice; and
designating the name of the second preset time slice as the name of the file.

7. The method of claim 1, wherein the multimedia resource includes at least one of a digital image format, an audio format, or a video format.

8. A system for storing a multimedia resource, comprising:
at least one storage device including one or more sets of instructions; and
at least one processor in communication with the at least one storage device, wherein when executing the one or more sets of instructions, the at least one processor is configured to cause the system to:
determine a time slice of the multimedia resource having a specified format in real time; and
store the multimedia resource to a corresponding file based on a corresponding relation between the time slice and a preset time slice.

9. The system of claim 8, wherein the at least one processor is further configured to cause the system to: prior to the storing the multimedia resource,
determine a plurality of preset time slices based on a time sequence; and
store the plurality of preset time slices, wherein each of the plurality of preset time slices and the corresponding file are named after a start time of the preset time slice.

10. The system of claim 9, wherein to store the multimedia resource to a corresponding file based on the corresponding relation between the time slice and the preset time slice, the at least one processor is further configured to cause the system to:
determine whether the time slice of the multimedia resource matches the preset time slice; and
in response to a determination that the time slice of the multimedia resource does not match the preset time slice, designate a name of the file storing the multimedia resource based on the time slice of the multimedia resource.

11. The system of claim 9, wherein to store the multimedia resource to a corresponding file based on the corresponding relation between the time slice and the preset time slice, the at least one processor is further configured to cause the system to:
determine whether the time slice of the multimedia resource matches the preset time slice;
in response to a determination that the time slice of the multimedia resource matches the preset time slice, determine a time length between a start time of the time slice of the multimedia resource and a storage time; and
store the multimedia resource to the corresponding file based on the time length.

12. The system of claim 11, wherein to store the multimedia resource to the corresponding file based on the time length, the at least one processor is further configured to cause the system to:
determine whether the time length is greater than or equal to a duration of the preset time slice;
in response to a determination that the time length is greater than or equal to the duration of the preset time slice, store the multimedia resource to a file corresponding to a second preset time slice, the second preset time slice being a next time slice adjacent to the preset time slice; and
in response to a determination that the time length is less than the duration of the preset time slice, store the multimedia resource to the corresponding file corresponding to the preset time slice.

13. The system of claim 12, wherein in response to a determination that the time length is greater than or equal to the duration of the preset time slice, to store the multimedia resource to the file corresponding to a second preset time slice, the at least one processor is further configured to cause the system to:
start a thread synchronization lock;
subsequently designate the storage time of the multimedia resource as the name of the second preset time slice; and
designate the name of the second preset time slice as the name of the file.

14. The system of claim 8, wherein the multimedia resource includes at least one of a digital image format, an audio format, or a video format.

15-21. (canceled)

22. A non-transitory computer readable medium, comprising at least one set of computer program for storing a multimedia resource, when accessed by at least one processor of a computing device, causes the computing device to execute a method, the method comprising:
determining a time slice of the multimedia resource having a specified format in real time; and
storing the multimedia resource to a corresponding file based on a corresponding relation between the time slice and a preset time slice.

23. The non-transitory computer readable medium of claim 22, wherein the method further comprising: prior to the storing the multimedia resource,
determining a plurality of preset time slices based on a time sequence; and
storing the plurality of preset time slices, wherein each of the plurality of preset time slices and the corresponding file are named after a start time of the preset time slice.

24. The non-transitory computer readable medium of claim 23, wherein the storing the multimedia resource to a corresponding file based on the corresponding relation between the time slice and the preset time slice further includes:
determining whether the time slice of the multimedia resource matches the preset time slice; and
in response to a determination that the time slice of the multimedia resource does not match the preset time slice, designating a name of the file storing the multimedia resource based on the time slice of the multimedia resource.

25. The non-transitory computer readable medium of claim 23, wherein the storing the multimedia resource to a corresponding file based on the corresponding relation between the time slice and the preset time slice further includes:
determining whether the time slice of the multimedia resource matches the preset time slice;
in response to a determination that the time slice of the multimedia resource matches the preset time slice, determining a time length between a start time of the time slice of the multimedia resource and a storage time; and
storing the multimedia resource to the corresponding file based on the time length.

26. The non-transitory computer readable medium of claim 25, wherein the storing the multimedia resource to the corresponding file based on the time length further includes:
determining whether the time length is greater than or equal to a duration of the preset time slice;
in response to a determination that the time length is greater than or equal to the duration of the preset time slice, storing the multimedia resource to a file corresponding to a second preset time slice, the second preset time slice being a next time slice adjacent to the preset time slice; and
in response to a determination that the time length is less than the duration of the preset time slice, storing the multimedia resource to the corresponding file corresponding to the preset time slice.

27. The non-transitory computer readable medium of claim 26, wherein in response to the determination that the time length is greater than or equal to the duration of the preset time slice, the storing the multimedia resource to the file corresponding to the second preset time slice further includes:
starting a thread synchronization lock;
subsequently designating the storage time of the multimedia resource as the name of the second preset time slice; and
designating the name of the second preset time slice as the name of the file.
